(19) United States
(12) Patent Application Publication
(10) Pub. No.: US 2017/0186250 A1
(43) Pub. Date: Jun. 29, 2017

(54) SYSTEM AND METHOD FOR DETERMINING MACHINE HANG TIME

(71) Applicant: Caterpillar Inc., Peoria, IL (US)

(72) Inventors: Darryl Collins, Jindalee (AU); Cherise Osborn, Norman Park (AU); Gregory M. Wood, Sinnamon Park (AU); Thomas F. Doherty, Holland Park (AU); Kevin E. Gates, Taringa (AU); Gregory Davis, Scarborough (AU)

(73) Assignee: Caterpillar Inc., Peoria, IL (US)

(21) Appl. No.: 14/980,197

(22) Filed: Dec. 28, 2015

(51) Int. Cl. G07C 5/08; G05B 19/042

(52) U.S. Cl. CPC G07C 5/0841; G05B 19/042

(57) ABSTRACT

A system for determining hang time for a machine operating at a worksite is provided. The system includes a sensing module associated with the machine. The sensing module is configured to track at least one parameter associated with the machine. The at least one parameter includes a machine heading, a machine speed, or a machine location. The system also includes a control module communicably coupled to the sensing module. The control module is configured to receive tracked information corresponding to the at least one parameter from the sensing module. The control module is also configured to analyze the tracked information corresponding to the at least one parameter, based on the received tracked information. The control module is further configured to determine the hang time for the machine, based on the analysis.

### TECHNICAL FIELD

The present disclosure relates to a system and a method for determining hang time for a machine, and more particularly to a system and a method for determining hang time of a number of machines operating at a worksite.

### BACKGROUND

It is essential to determine hang time associated with machines operating at a worksite. Current determination methods are based on observing events sent from the machines and trucks to identify when dippers have been deposited into the trucks. This does not provide relevant information required to determine hang time. The current solution significantly overestimates hang time with a result that the performance of a particular operation cannot be accurately assessed by customers and personnel in charge of the worksite. Inefficiencies in the determination of hang time can have a large impact on the operation at the worksite, and may lower efficiency and production on site.

U.S. Pat. No. 7,941,158 describes a system containing a central computer unit having a first database controlled by a first logic unit. At least one mobile computer unit is joined with the mobile equipment. Each of the mobile computer units has a second database controlled by a second logic unit. At least one wireless communication device enables communication between said first logic units and said second logic unit, wherein said mobile computer unit is operable independent of the first logic unit.

### SUMMARY OF THE DISCLOSURE

In one aspect of the present disclosure, a system for determining hang time for a machine operating at a worksite is provided. The system includes a sensing module associated with the machine. The sensing module is configured to track at least one parameter associated with the machine. The at least one parameter includes a machine heading, a machine speed, a machine location, or a machine velocity. The system also includes a control module communicably coupled to the sensing module. The control module is configured to receive tracked information corresponding to the at least one parameter from the sensing module. The control module is also configured to analyze the tracked information corresponding to the at least one parameter, based on the received tracked information. The control module is further configured to determine the hang time for the machine, based on the analysis.

In another aspect of the present disclosure, a method of determining hang time for a machine operating at a worksite is provided. The method includes tracking at least one parameter associated with the machine, wherein the at least one parameter includes a machine heading, a machine speed, a machine location, or a machine velocity. The method also includes analyzing tracked information corresponding to the at least one parameter, based on the tracking. The method further includes determining the hang time for the machine, based on the analysis.

In yet another aspect of the present disclosure, a computer program product comprising a non-transitory computer usable medium having a computer readable program code embodied therein is provided. The computer readable program code is configured to implement a method for determining hang time for a machine. The method includes tracking at least one parameter associated with the machine, wherein the at least one parameter includes a machine heading, a machine speed, a machine location, or a machine velocity. The method also includes analyzing tracked information corresponding to the at least one parameter, based on the tracking. The method further includes determining the hang time for the machine, based on the analysis.

Other features and aspects of this disclosure will be apparent from the following description and the accompanying drawings.

### BRIEF DESCRIPTION OF THE DRAWINGS

FIG. 1 is a perspective view of an exemplary worksite, according to one embodiment of the present disclosure;

FIG. 2 is a block diagram of a system for determining hang time for a machine operating at the worksite, according to one embodiment of the present disclosure; and

FIG. 3 is a flowchart for a method of determining the hang time for the machine operating at the worksite.

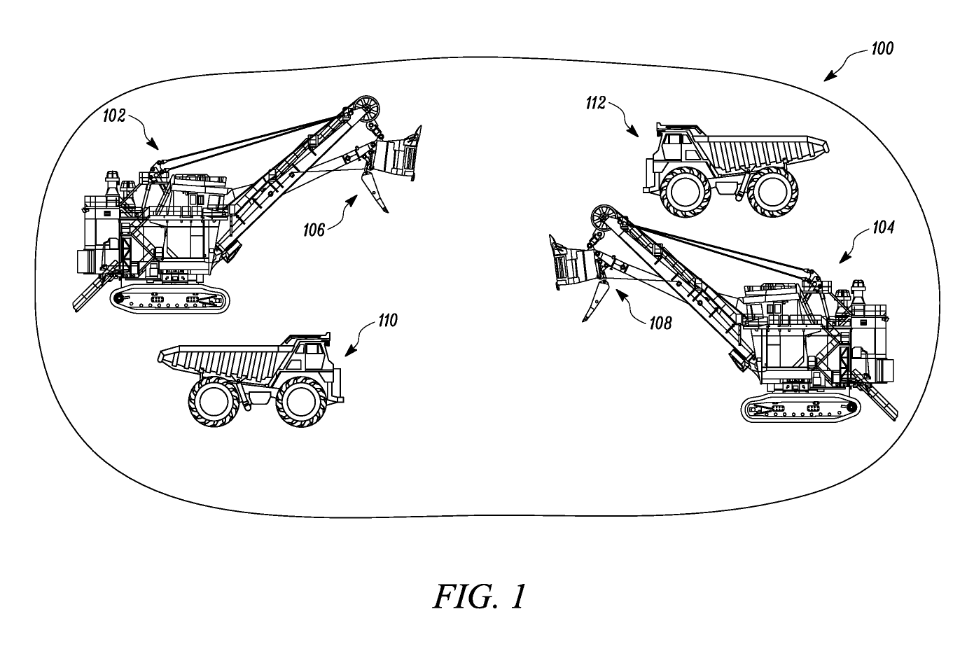

### DETAILED DESCRIPTION

Wherever possible, the same reference numbers will be used throughout the drawings to refer to the same or the like parts. FIG. 1 is a schematic view of an exemplary worksite 100. In one example, the worksite 100 may embody a mining worksite. A number of machines 102, 104 may operate on the worksite 100 to perform various work operations, such as, earth drilling, rock excavation, mineral extraction, and the like.

In one example, the machines 102, 104 may embody a shovel, such as an electric mining shovel. Although the machines 102, 104 described in connection with this disclosure are embodied as shovels, the machines 102, 104 may include any other type of same or different machine, such as those used for drilling, hammering, loading and unloading of payload, etc., without any limitation. For example, the machines 102, 104 may embody a loader such as a load haul dump, a back hoe loader, a wheel loader, etc.

Further, the machines 102, 104 may embody an excavator, a trencher, or any other work machine known in the art. For the purpose of simplicity only two machines 102, 104 are described as being deployed at the worksite 100. However, the number of machines operating at the worksite 100 may vary based on the operational requirements. The machine 102, 104 also includes a work implement 106, 108 associated therewith. The work implement 106, 108 may embody buckets, blades, boring tools, rippers, and the like. The work implement 106, 108 is attached to the machine 102, 104 by at least one linkage, for example, a boom and a stick.

The worksite 100 also includes load carrying vehicles 110, 112 deployed at the worksite 100. The load carrying vehicles 110, 112 are adapted to receive payload, such as pieces of rocks, soil, etc., from the machines 104, 106 after the machine 104, 106 has performed a particular work operation. The load carrying vehicles 110, 112 may embody a dump truck or any other vehicle or machine capable of carrying and transporting payload, without any limitations. For exemplary purposes, only two load carrying vehicles 110, 112 are described as being deployed at the worksite 100. However the number of load carrying vehicles 110, 112 operating at the worksite 100 may vary based on operational requirements and the number of machines 102, 104 deployed at the worksite 100.

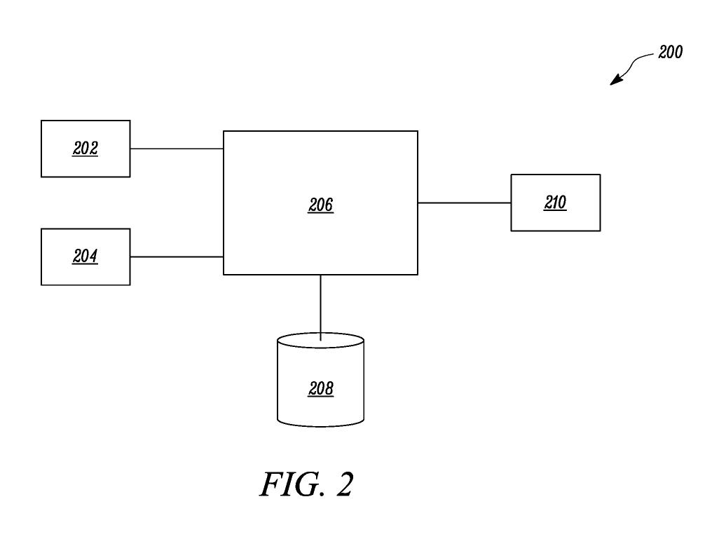

The present disclosure relates to a system 200 (see FIG. 2) for determining hang time for the machines 102, 104 operating at the worksite 100. In one example, the system 200 determines the hang time of each machine 102, 104 operating at the worksite 100. In another example, the system 200 determines a total hang time incurred by all the machines 102, 104 operating at the worksite 100. For exemplary and illustrative purposes, the present disclosure will be explained with respect to the determination of the hang time of the machine 102. However, it should be noted that the description provided below is equally applicable to all the machines operating at the worksite 100.

Referring to FIG. 2, a block diagram of the system 200 is shown. The system 200 includes a first sensing module 202 associated with the machine 102. The first sensing module 202 tracks information corresponding to a parameter associated with the machine 102. The parameter may include a machine heading, a rate of change of machine heading, a machine speed, a machine location, or a machine velocity. The first sensing module 202 generates signals corresponding to the tracked information of one or more parameters associated with the machine 102.

In one example, the tracked information for the machine heading corresponds to a movement of the work implement 106 of the machine 102 or a work operation being performed by the work implement 106 of the machine 102, or both. The movement of the work implement 106 may include any one of a swinging, vertical movement, horizontal movement, or rotation of the work implement 106, without any limitations. The first sensing module 202 may include sensors that either directly detect the movement of the work implement 106 of the machine 102 or detect the movement of the work implement 106 with respect to the machine 102. Further, the first sensing module 202 may include sensors that detect whether the machine 102 is performing the work operation. The first sensing module 202 may include, one or a combination of a motion sensor, a proximity sensor, a gyroscopic sensor, an inclinometer, a displacement sensor, a position sensor, an inertial sensor, a laser sensor, an ultrasonic sensor, an infrared sensor, and the like, without limiting the scope of the present disclosure. Further, the first sensing module 202 may also utilize Global Positioning Systems (GPS) to detect the movement of the work implement 106 of the machine 102 or the work operation being performed by the work implement 106.

In another example, the tracked information for the machine heading corresponds to a direction in which the machine 102 is moving. Accordingly, the first sensing module 202 may include one or a combination of sensors that detect and generate signals corresponding to the heading direction of the machine 102. The sensors may include one or a combination of RADAR, a Radio Frequency Identification (RFID) sensor, a laser sensor, a capacitive sensor, an electromagnetic sensor, a GPS based sensor, an ultrasonic sensor, an infrared sensor, an image capturing device, and the like, without limiting the scope of the present disclosure.

The first sensing module 202 also tracks the information corresponding to the machine speed. The tracked information for the machine speed corresponds to a movement of the machine 102 at the worksite 100. For example, the machine speed may indicate that the machine 102 is traveling on the worksite 100. In order to measure the machine speed, the first sensing module 202 may include any known types of speed detection sensor, such as a speed sensor, a speedometer, a wheel speed sensor, a hall effect sensor, and the like.

The first sensing module 202 also tracks the information corresponding to the machine location. The first sensing module 202 may utilize the GPS system that allows detection of the machine location, based on system requirements. In another example, the first sensing module 202 may make use of positioning systems, such as, laser referencing, dead reckoning, and the like, for detecting the machine location. Alternatively, the first sensing module may include any other sensing means for the detection of the machine location known in the art. Further, for detecting the machine velocity, the first sensing module 202 may include a combination of sensors that detect the machine speed and the heading direction of the machine 102 in order to compute the machine velocity.

The system 200 also determines the hang time of the machine 102 based on an availability of the load carrying vehicle 110, 112 that is present within a reach radius of the machine 102. In this example, the load carrying vehicle 110 is present proximal to the machine 102, and hence the disclosure will be described in relation to the availability of the load carrying vehicle 110.

For determining the availability of the load carrying vehicle 110, a second sensing module 204 is associated with the load carrying vehicle 110. The second sensing module 204 tracks information corresponding to a speed of the load carrying vehicle 110. For detecting the speed of the load carrying vehicle 110, the second sensing module 204 may include one or a combination of known types of speed detection sensors, such as a speed sensor, a speedometer, a wheel speed sensor, a hall effect sensor, and the like. Further, the second sensing module 204 also tracks information corresponding to a position/location of the load carrying vehicle 110. In such an example, the system 200 determines a distance between the machine 102 and the load carrying vehicle 110 in order to determine the availability of the load carrying vehicle 110. For detecting the location of the load carrying vehicle 110, the second sensing module 204 may include GPS system, laser referencing, dead reckoning, or any other sensing means that allows detection of the location of the load carrying vehicle 110.

The system 200 includes a control module 206. The control module 206 is communicably coupled to the first and second sensing module 202, 204, and is adapted to receive signals therefrom. More particularly, the control module 206 receives the tracked information from the first sensing module 202 and the second sensing module 204 corresponding to the machine heading, the rate of change of machine heading, the machine speed, the machine location, the machine velocity, and the availability of the load carrying vehicle 110, respectively. The control module 206 analyzes the tracked information received from the first and second sensing modules 202, 204. For analysis of the tracked information, the control module 206 compares the received tracked information for the machine heading, the rate of change of machine heading, the machine speed, the machine location, the machine velocity, and the availability of the load carrying vehicle 110 with a corresponding predetermined threshold. The predetermined thresholds corresponding to the machine heading, the rate of change of machine heading, the machine speed, the machine location, the machine velocity, and the availability of the load carrying vehicle 110 are stored in a database 208. The control module 206 may retrieve values of the predetermined thresholds from the database 208 as per system requirements.

Based on the analysis, the control module 206 determines the hang time of the machine 102. For example, the control module 206 receives the tracked information corresponding to the machine heading and the rate of change of machine heading from the first sensing module 202. Upon receiving the tracked information corresponding to the movement of the work implement 106 or the work operation being performed by the work implement 106 of the machine 102, the control module 206 compares the tracked information with the corresponding predetermined threshold. Based on the comparison, the control module 206 determines whether the machine 102 is in operation or idle/hanging. If the machine 102 is hanging, the control module 206 determines and clocks the hang time associated with the machine 102.

In one example, the control module 206 also receives the tracked information corresponding to the machine speed. The tracked information corresponding to the machine speed may or may not be associated with machine operation. In such an example, the control module 206 uses the tracked information corresponding to the machine speed in conjunction with the tracked information corresponding to the movement of the work implement 106 and/or the work operation performed by the work implement 106 to determine whether the machine 102 is in operation or idle/hanging. If the machine 102 is hanging, the control module 206 determines and clocks the hang time associated with the machine 102.

In another example, the control module 206 receives the tracked information corresponding to the machine location. The tracked information corresponding to the machine location may or may not be associated with machine operation. In such an example, the control module 206 uses the tracked information corresponding to the machine location in conjunction with the tracked information corresponding to the movement of the work implement 106 and/or the work operation performed by the work implement 106 to determine whether the machine 102 is in operation or idle/hanging. If the control module 206 determines that the machine 102 is present at a work location allocated for a particular operation and the work implement 106 is moving or the work operation is being performed by the work implement 106, the control module 206 determines that the machine 102 is not hanging. However, if the machine 102 is hanging, the control module 206 determines and clocks the hang time associated with the machine 102. Similarly, the control module 206 uses the tracked information corresponding to the machine velocity in conjunction with the tracked information corresponding to the movement of the work implement 106 and/or the work operation performed by the work implement 106 to determine whether the machine 102 is in operation or idle/hanging. If the machine 102 is hanging, the control module 206 determines and clocks the hang time associated with the machine 102

In yet another example, the control module 206 receives tracked information corresponding to the speed and the location of the load carrying vehicle 110 from the second sensing module 204. In such an example, the control module 206 compares the speed and the location of the load carrying vehicle 110 with the corresponding predetermined thresholds stored in the database 208. If the load carrying vehicle 110 is stationary and present within the reach radius of the machine 102, the load carrying vehicle 110 is considered available for loading. Hence, the control module 206 determines that the machine 102 is not idle or hanging as the load carrying vehicle 110 is available for loading. However, if no load carrying vehicle is available for loading, the control module 206 determines that the machine 102 is hanging. Accordingly, the control module 206 clocks the hang time associated with the machine 102. The control module 206 collates the hang time determined using the different parameters and generates a total hang time of the machine 102. Further, the control module 206 also collates the hang time determined using the different parameters and generates the total hang time incurred by all the machines 102 operating at the worksite 100.

Further, an output module 210 may be communicably coupled to the control module 206. The output module 210 receives signals pertaining to the determined hang time from the control module 206. Further, the output module 210 displays the determined hang time of the machine 102 to a personnel in charge of the worksite 100. In one example, the output module 210 may display the hang time associated with each machine 102, 104 operating at the worksite 100. In another example, the output module 210 may display the total hang time incurred by the machines 102, 104 operating at the worksite 100. The output module 210 may be present within the machines 102, 104 or at a location external to the machine 102, 104, based on system requirements.

The output module 210 may embody a visual output or an audio output. In one example, wherein the output module 210 is embodied as a visual output, the output module 210 may include any one of a digital display device, an LCD device, an LED device, a CRT monitor, a touchscreen device, or any other display device known in the art. In one example, the output module 210 may notify the person regarding the determined hang time, through a text message. In a situation wherein the output module 210 is embodied as the audio output, an audio clip may be heard, thereby alerting the personnel of the determined hang time. It should be noted that the output module 210 may include any other means other than those listed above.

The control module 206 of the system 200 may store a computer program product in one or more non-transitory computer readable medium(s). Common forms of computer readable media include, for example, a floppy disk, a flexible disk, hard disk, magnetic tape, or any other magnetic medium, a CD-ROM, DVD, any other optical medium, or any other medium. Further, the computer readable medium may have a computer readable program code stored therein. The computer readable program code may store and execute instructions for determination of the hang time for the machine 102, 104.

The control module 206 may be present at the worksite 100 or at a remote location, such as a base station, without any limitations. The control module 206 may be a microprocessor or other processor known in the art. The control module 206 may embody a single microprocessor or multiple microprocessors for receiving signals from components of the system 200. Numerous commercially available microprocessors may be configured to perform the functions of the control module 206. A person of ordinary skill in the art will appreciate that the control module 206 may additionally include other components and may also perform other functions not described herein.

### INDUSTRIAL APPLICABILITY

The system 200 disclosed herein, reliably and accurately determines hang time associated with the machines 102, 104. Hence, the personnel at the worksite 100 and third party customers can easily identify bottlenecks and areas for improvement in one or more operations at the worksite 100, in order to increase efficiency and production on site.

The system 200 allows real time tracking of the hang time for the machine 102, 104. The first and second sensing modules 202, 204 do not lead to any additional cost, as the sensors of the first and second sensing modules 202, 204 are already available on the machines 102, 104 and the load carrying vehicles 110, 112. The system 200 provides an easy to implement and low cost solution for determining the hang time for the machine 102, 104. The system 200 can be easily retrofitted on existing machines without affecting the hardware of the respective machines. Further, the system 200 is not worksite specific or machine specific, and hence may be employed at different worksites or machines.

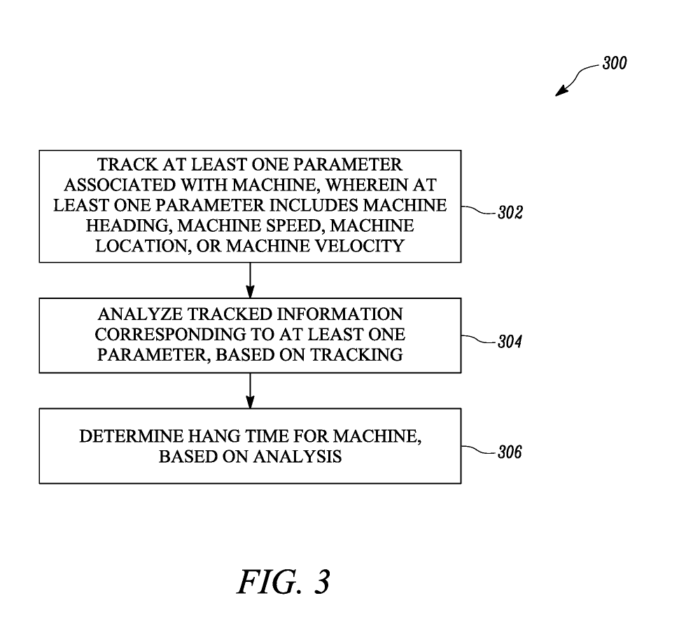

FIG. 3 is a flowchart for a method 300 of determining the hang time for the machine 102, 104 operating at the worksite 100. The machine 102, 104 may include the shovel operating at the worksite 100. At step 302, the first sensing module 202 tracks the parameters of the machine 102. The parameters include the machine heading, the rate of change of machine heading, the machine speed, the machine location, or the machine velocity. The tracked information for the machine heading corresponds to at least one of the movement of the work implement 106, 108 of the machine 102, 104 and the work operation being performed by the machine 102, 104. Also, the tracked information for the machine speed corresponds to the movement of the machine 102, 104 at the worksite 100.

Further, the second sensing module 204 tracks the parameters for the load carrying vehicle 110, 112 that receives payload from the machine 102, 104, respectively. The second sensing module 204 tracks the information corresponding to the speed of the load carrying vehicle 110, 112 present within the reach radius of the machine 102, 104, respectively. The second sensing module 204 also tracks the information corresponding to the location of the load carrying vehicle 110, 112.

At step 304, the control module 206 analyzes the tracked information corresponding to the parameter of the machine 102, 104 from the first sensing module 202. Further, the control module 206 compares the tracked information corresponding to the parameter of the machine 102, 104 with the predetermined threshold. The control module 206 also receives the information corresponding to the speed of the load carrying vehicle 110, 112 present within the reach radius of the machine 102, 104 from the second sensing module 204. The load carrying vehicle 110, 112 receives the payload from the machine 102, 104. The control module 206 also receives the information corresponding to the location of the load carrying vehicle 110, 112 from the second sensing module 204. Based on the received information, the control module 206 determines the availability of the load carrying vehicle 110, 112. Further, based on the availability of the load carrying vehicle 110, 112, the control module 206 determines the hang time of the machine 102, 104.

At step 306, the hang time for each machine 102, 104 are determined based on the analysis. In one example, the control module 206 may determine the total hang time incurred by all the machines 102, 104 operating at the worksite 100. Further, the control module 206 is communicably coupled to the output module 210 that displays the determined hang time of the machine 102, 104 to the personnel.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for determining hang time for a machine operating at a worksite, the system comprising:
a sensing module associated with the machine, the sensing module configured to track at least one parameter associated with the machine, wherein the at least one parameter includes a machine heading, a machine speed, a machine location, or a machine velocity; and
a control module communicably coupled to the sensing module, the control module configured to:
receive tracked information corresponding to the at least one parameter from the sensing module;
analyze the tracked information corresponding to the at least one parameter, based on the received tracked information; and
determine the hang time for the machine, based on the analysis.

2. The system of claim 1, wherein the machine is a shovel operating at the worksite.

3. The system of claim 1, wherein the control module is further configured to:
determine a total hang time incurred by a plurality of machines operating at the worksite.

4. The system of claim 1, wherein the control module is further configured to:
compare the tracked information corresponding to the at least one parameter with a predetermined threshold.

5. The system of claim 1, wherein the tracked information for the machine heading corresponds to at least one of a movement of a work implement of the machine and a work operation being performed by the machine.

6. The system of claim 1, wherein the tracked information for the machine speed corresponds to a movement of the machine at the worksite.

7. The system of claim 1, wherein the control module is further configured to:
receive information corresponding to a speed of a load carrying vehicle present within a reach radius of the machine, wherein the load carrying vehicle is configured to receive payload from the machine;
receive information corresponding to a location of the load carrying vehicle;
determine an availability of the load carrying vehicle based on the received information; and
determine the hang time of the machine, based on the availability of the load carrying vehicle.

8. A method of determining hang time for a machine operating at a worksite, the method comprising:
tracking at least one parameter associated with the machine, wherein the at least one parameter includes a machine heading, a machine speed, a machine location, or a machine velocity;
analyzing tracked information corresponding to the at least one parameter, based on the tracking; and
determining the hang time for the machine, based on the analysis.

9. The method of claim 8, wherein the machine is a shovel operating at the worksite.

10. The method of claim 8, further comprising:
determining a total hang time incurred by a plurality of machines operating at the worksite.

11. The method of claim 8, further comprising:
comparing the tracked information corresponding to the at least one parameter with a predetermined threshold.

12. The method of claim 8, further comprising:
receiving information corresponding to a speed of a load carrying vehicle present within a reach radius of the machine, wherein the load carrying vehicle is configured to receive payload from the machine;
receiving information corresponding to a location of the load carrying vehicle;
determining an availability of the load carrying vehicle based on the received information; and
determining the hang time of the machine, based on the availability of the load carrying vehicle.

13. The method of claim 8, wherein the tracked information for the machine heading corresponds to at least one of a movement of a work implement of the machine and a work operation being performed by the machine.

14. The method of claim 8, wherein the tracked information for the machine speed corresponds to a movement of the machine at the worksite.

15. The method of claim 8, further comprising:
displaying the determined hang time of the machine to a personnel.

16. A computer program product comprising a non-transitory computer usable medium having a computer readable program code embodied therein, the computer readable program code configured to implement a method for determining hang time for a machine, the method comprising:
tracking at least one parameter associated with the machine, wherein the at least one parameter includes a machine heading, a machine speed, a machine location, or a machine velocity;
analyzing tracked information corresponding to the at least one parameter, based on the tracking; and
determining the hang time for the machine, based on the analysis.

17. The method of claim 16, wherein the machine is a shovel operating at a worksite.

18. The method of claim 16, further comprising:
determining a total hang time incurred by a plurality of machines operating at the worksite.

19. The method of claim 16, further comprising:
comparing the tracked information corresponding to the at least one parameter with a predetermined threshold.

20. The method of claim 16, further comprising:
receiving information corresponding to a speed of a load carrying vehicle present within a reach radius of the machine, wherein the load carrying vehicle is configured to receive payload from the machine;
receiving information corresponding to a location of the load carrying vehicle;
determining an availability of the load carrying vehicle based on the received information; and
determining whether the machine is hanging based on the availability of the load carrying vehicle.
